(19) United States
(12) Patent Application Publication
(10) Pub. No.: US 2010/0033660 A1
(43) Pub. Date: Feb. 11, 2010

(54) ARRAY SUBSTRATE AND LIQUID CRYSTAL DISPLAY PANEL

(76) Inventors: Tetsuyuki Yamada, Saitama-shi (JP); Kiyoshi Shohara, Saitama-shi (JP); Takashi Doi, Fukaya-shi (JP); Ryuichi Arai, Kumagaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/512,268

(22) Filed: Jul. 30, 2009

(30) Foreign Application Priority Data
Aug. 7, 2008 (JP) 2008-204416

(51) Int. Cl. G02F 1/1333

(52) U.S. Cl. 349/110

(57) ABSTRACT

An array substrate includes scanning lines, signal lines, switching elements, an insulating film, a reception pattern which has a first frame, and a second frame, in which a groove is formed between the first frame and second frame, a projection which is formed in a part of the groove adjacent to the first frame, extended in a first coating direction, and controls the flow of light-shielding material, and a frame-like light-shielding pattern, which includes a first light-shielding part formed by coating the groove with the light-shielding material in the first coating direction by using an ink-jet method or a dispenser method, and is formed by coating the groove several times with the light-shielding material by using an ink-jet method or a dispenser method.

### CROSS-REFERENCE TO RELATED APPLICATIONS

This application is based upon and claims the benefit of priority from prior Japanese Patent Application No. 2008-204416, filed Aug. 7, 2008, the entire contents of which are incorporated herein by reference.

### BACKGROUND OF THE INVENTION

1. Field of the Invention

The present invention relates to an array substrate and a liquid crystal display panel having the array substrate.

2. Description of the Related Art

Generally, a liquid crystal display device is well known as an image display device. Recently, a liquid crystal display device has been technically advanced, and demanded as a thin, power saving, high quality image display device. Particularly, an active matrix type color liquid crystal display device having a switching element such as a thin film transistor (TFT) has been developed. A liquid crystal display device has a liquid crystal display panel comprising an array substrate, a counter substrate, a liquid crystal layer, and a color filter. A polarizer is provided on both sides of a liquid crystal display panel.

In an array substrate, scanning lines and signal lines are wired in a matrix. A TFT is placed close to each intersection of the scanning line and signal line. A TFT comprises a gate electrode connected to a scanning line, a source electrode connected to a signal electrode, and a drain electrode connected to an auxiliary capacitor element and pixel electrode.

When the gate electrode and source electrode are turned on, a current flows in the source electrode and drain electrode, the potential at the auxiliary capacitor element and pixel electrode becomes equal to a signal potential, and a signal voltage is applied to the liquid crystal layer. As a means to eliminate a clearance between a source electrode and a pixel electrode on the plane surface of a substrate, a technique has been developed, in which an insulating film is provided on wiring such as a source line, and a pixel electrode is formed on the insulating film. In this case, a drain electrode and a pixel electrode are connected through a through-hole formed on an insulating film.

As disclosed in Jpn. Pat. Appln. KOKAI Publication No. 2000-122072, a color filter and a frame are generally formed by photolithography on a principal surface of an array substrate or counter substrate. However, photolithography requires many processes (four processes), such as coating, exposing, developing and baking, which makes it difficult to reduce the manufacturing cost. Therefore, a method of forming a color filter by an ink-jet method has been developed, as disclosed in Jpn. Pat. Appln. KOKAI Publication Nos. H10-170712 and 2002-55223.

As a known ink-jet method, a reception layer is provided on a principal surface of an array substrate or counter substrate, and the substrate is dyed together with the reception layer (refer to Jpn. Pat. Appln. KOKAI Publication No. H10-148713), or another projected reception pattern is provided on a principal surface of an array substrate or counter substrate, and a dying layer is formed between the reception patterns (refer to Jpn. Pat. Appln. KOKAI Publication No. 2000-353594).

Particularly, when a frame is formed by an ink-jet method, a frame must be provided all around the periphery of a display area, and it is necessary to move from one end to the other end of a substrate while discharging ink, and then turn a substrate by 90°, and discharge the ink again at a predetermined position (refer to Jpn. Pat. Appln. KOKAI Publication No. 2007-241219).

However, when a frame is formed by the above ink-jet method, it is difficult to control the flow of ink owing to the unevenness and different contact angle of a base metallic film and organic film. Particularly, ink flows along a reception pattern upon the first discharge, and a light-shielding layer is formed all around a reception pattern. When a substrate is turned by 90° and coated with ink for the second time, the previously coated ink rejects the newly applied ink.

This causes omission of light in a frame when a liquid crystal display device is turned on, deteriorates the contrast, or causes defective display. Further, the ink flows out to a display area, and degrades the quality of the display.

### BRIEF SUMMARY OF THE INVENTION

According to an aspect of the invention, there is provided an array substrate comprising:

scanning lines provided on a substrate, and layered on a display area;

signal lines provided on the substrate, layered on the display area, and intersected with the scanning lines;

switching elements provided close to the intersections of the scanning lines and signal lines;

an insulating film formed on the substrate, scanning lines, signal lines and switching elements layered, in being layered on the display area;

a reception pattern which has a first frame formed along the periphery of the insulating film, and a second frame formed opposite to the insulating film through the first frame, and spaced apart from the first frame, in which a groove is formed between the first frame and second frame;

a projection which is formed in a part of the groove adjacent to the first frame, extended in a first coating direction, and controls the flow of light-shielding material; and

a frame-like light-shielding pattern, which includes a first light-shielding part formed by coating the groove with the light-shielding material in the first coating direction by using an ink-jet method or a dispenser method, and is formed by coating the groove several times with the light-shielding material by using an ink-jet method or a dispenser method.

According to another aspect of the invention, there is provided a liquid crystal panel comprising:

an array substrate comprising scanning lines provided on a substrate, and layered on a display area; signal lines provided on the substrate, layered on the display area, and intersected with the scanning lines; switching elements provided close to the intersections of the scanning lines and signal lines; an insulating film formed on the substrate, scanning lines, signal lines and switching elements layered, in being layered on the display area; a reception pattern which has a first frame formed along the periphery of the insulating film, a second frame formed opposite to the insulating film through the first frame, and spaced apart from the first frame, in which a groove is formed between the first frame and second frame; a projection which is formed in a part of the groove adjacent to the first frame, extended in a first coating direction, and controls the flow of light-shielding material; and

a frame-like light-shielding pattern, which includes a first light-shielding part formed by coating the groove with the light-shielding material in the first coating direction by using an ink-jet method or a dispenser method, and is formed by coating the groove several times with the light-shielding material by using an ink-jet method or a dispenser method;

a counter substrate arranged opposite to the array substrate; and

a liquid crystal layer held between the array substrate and counter substrate.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a liquid crystal display panel according to an embodiment of the invention;

FIG. 2 is a schematic plan view of the liquid crystal display panel shown in FIG. 1;

FIG. 3 is a plan view of an array substrate shown in FIGS. 1 and 2;

FIG. 4 is a magnified plan view of the array substrate, particularly showing a wiring structure of the array substrate;

FIG. 5 is a magnified sectional view of the liquid crystal display panel, particularly showing a structure of the liquid crystal display panel;

FIG. 6 is a magnified schematic sectional view showing the peripheral edge portion of the liquid crystal display panel;

FIG. 7 is a magnified plan view of the array substrate, particularly showing a reception pattern, a projection, and a light-shielding pattern;

FIG. 8 is a plan view showing nine array substrates formed on a mother glass by a method of manufacturing the liquid crystal display panel;

FIG. 9 is a plan view showing a color filter, a reception pattern, and a projection formed by a method of manufacturing the liquid crystal display panel;

FIG. 10 is a plan view showing the state that light-shielding ink is applied in a first coating direction by using an ink-jet unit, in a method of manufacturing the liquid crystal display panel;

FIG. 11 is a sectional view showing the state of coating the light-shielding ink, as in FIG. 10;

FIG. 12 is a plan view showing the state that a first light-shielding part is formed by a method of manufacturing the liquid crystal display panel;

FIG. 13 is a plan view showing the state that light-shielding ink is applied in a second coating direction by using an ink-jet unit, in a method of manufacturing the liquid crystal display panel;

FIG. 14 is a plan view of a modification of the projection in the above embodiment;

FIG. 15 is a plan view of another modification of the projection in the above embodiment; and

FIG. 16 is a plan view of a comparative example of the liquid crystal display panel in the above embodiment.

### DETAILED DESCRIPTION OF THE INVENTION

Hereinafter, detailed explanation will be given of a liquid crystal display panel according to an embodiment of the invention, and a method of manufacturing a liquid crystal display panel with reference to the accompanying drawings. First, a configuration of a liquid crystal display panel will be explained. In this embodiment, a liquid crystal display panel is of a color filter on array (COA) type.

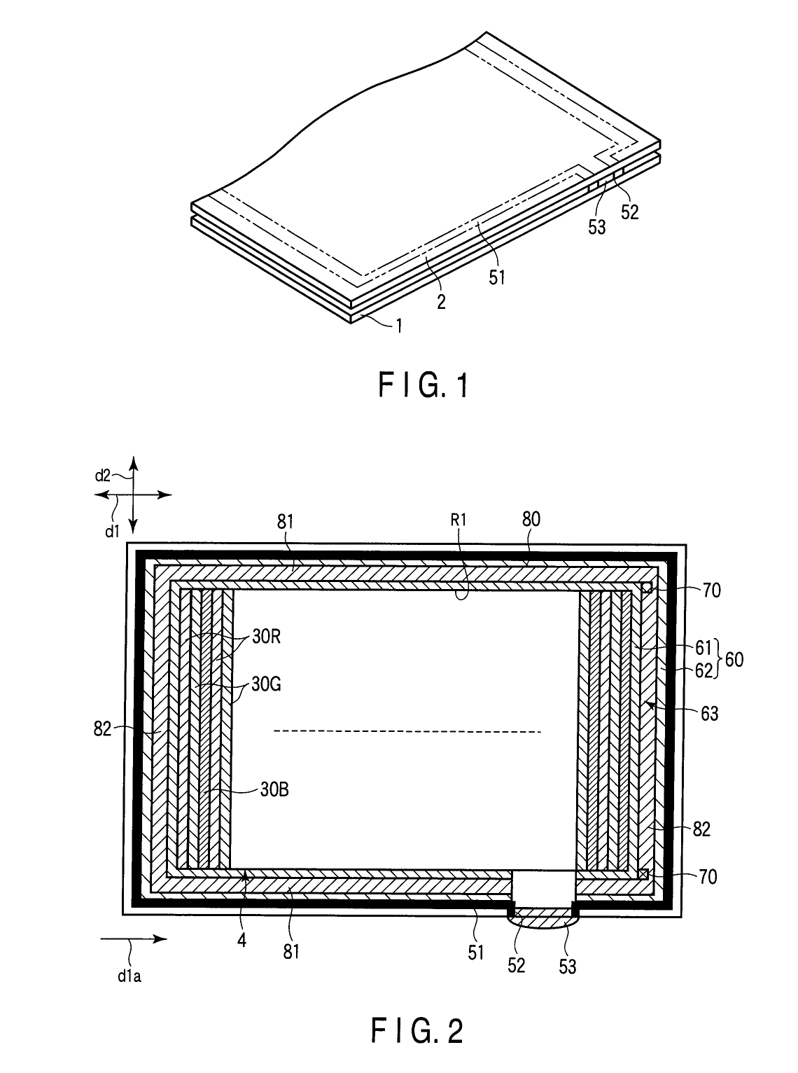

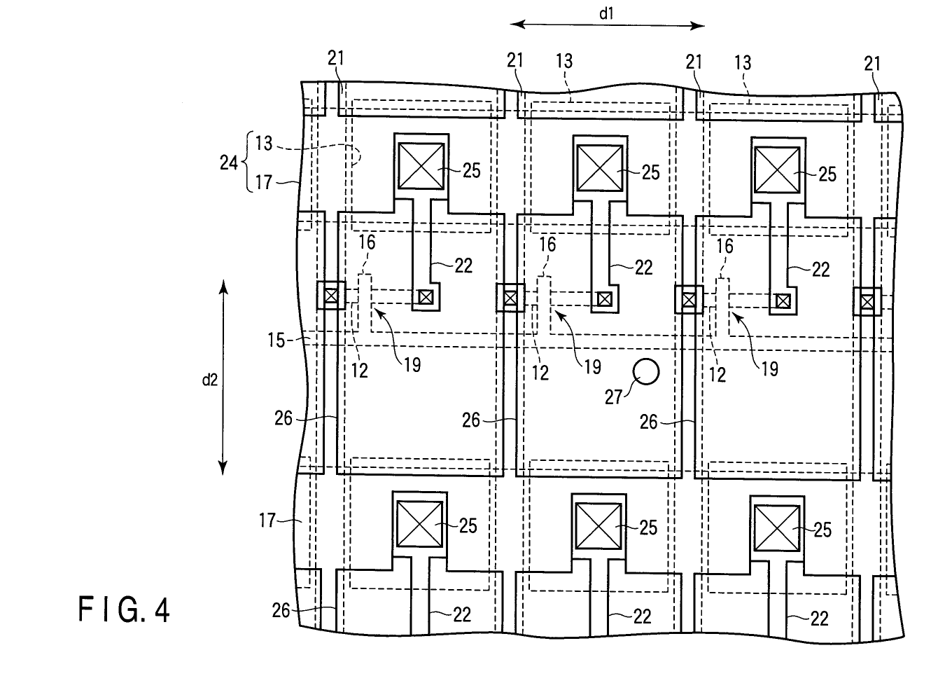

As shown in FIGS. 1 to 5, a liquid crystal display panel comprises an array substrate 1, a counter substrate 2 arranged opposite to the array substrate with a predetermined gap, a liquid crystal layer 3 held between these substrates, and a color filter 4. On the outside surfaces of the array substrate 1 and counter substrate 2, a not-shown polarizer is provided. On the outside surface of the array substrate 1, a not-shown backlight unit is provided. The array substrate 1 and counter substrate 2 have a rectangular display area R1. The color filter 4 is provided in the display area R1 of the array substrate 1.

The array substrate 1 has a glass substrate 11 as a transparent insulating substrate. In the display area R1 on the glass substrate 11, scanning lines 15 and signal lines 21 are arranged in a grid. The scanning lines 15 are extended in a first direction d1, and spaced parallel in a second direction d2 orthogonal to the first direction. The signal lines 21 are extended in the second direction d2 intersecting with the scanning lines 15, and spaced parallel in the first direction d1.

On the glass substrate 11, auxiliary capacitor lines 17 constituting auxiliary capacitor elements 24 are formed. The auxiliary capacitor lines 17 are extended in the first direction d1 intersecting with the signal lines 21, and spaced parallel in the second direction d2. The auxiliary capacitor lines 17 are extended parallel to the scanning lines 15.

The array substrate 1 and counter substrate 2 have a matrix of pixels 20 layered on an area surrounded by the signal lines 21 and auxiliary capacitor lines 17. Namely, each pixel 20 is provided over the area surrounded by two adjacent signal lines 21 and two adjacent auxiliary capacitor lines 17. A TFT 19 is provided as a switching element in the pixel 20 on the array substrate 1. Specifically, the TFT 19 is provided close to each point of intersection of the scanning line 15 and signal line 21.

The TFT 19 has a semiconductor film 12 made of amorphous silicon (a-Si) or polysilicon (p-Si), and a gate electrode 16 formed by an extended part of the scanning line 15. In this embodiment, the semiconductor film 12 and auxiliary capacitor electrode 13 described later are made of polysilicon.

Specifically, in the display area R1 on the glass substrate 11, the semiconductor film 12 and auxiliary capacitor electrode 13 are formed, and a gate insulating film 14 is formed on the glass substrate, semiconductor film and auxiliary capacitor electrode. On the gate insulating film 14, the scanning lines 15, gate electrodes 16 and auxiliary capacitor lines 17 are provided. The auxiliary capacitor lines 17 and auxiliary capacitor electrodes 13 oppose each other through the gate insulating film 14. An interlayer insulating film 18 is formed on the gate insulating film 14, scanning lines 15, gate electrodes 16 and auxiliary capacitor lines 17.

On the interlayer insulating film 18, the signal lines 21 and contact electrodes 22 are formed. Each contact electrode 22 is connected to a drain area of the semiconductor film 12 and a pixel electrode 26 described later, through a contact hole. The contact electrode 22 is connected to the auxiliary capacity electrode 13 through another contact hole. The auxiliary capacity line 17 is formed in the area except the part where the auxiliary capacitor electrode 13 is connected to the contact electrode 22.

The signal lines 21 are connected to a source area of the semiconductor film 12 through a contact hole. A protective insulating film 23 is formed on the interlayer insulating film 18, signal lines 21, and contact electrode 22. On the protective insulating film 23, a color filter 4 is formed as an insulating film. In this embodiment, the color filter 4 has red colored layers 30R, green colored layers 30G, and blue colored layers 30B.

On the colored layers 30R, 30G and 30B, columnar spacers 27 are formed as spacers.

On the colored layers 30R, 30G and 30B, pixel electrodes 26 are formed by transparent conductive films of indium-tin oxide (ITO). Contact holes 25 are formed on the protective insulating film 23 and colored layers 30R, 30G and 30B layered on the auxiliary capacitor lines 17. The contact holes 25 are provided in the pixels 20.

Each pixel electrode 26 is connected to the contact electrode 22 through the contact hole 25. The peripheral edge portion of each pixel electrode 26 is layered on the auxiliary capacitor lines 17 and signal lines 21. The pixel electrode 26 forms the pixel 20. The auxiliary capacitor line 17 and signal line 21 function as a black matrix (BM). An alignment film 28 is formed on the color filter 4 and pixel electrode 26.

In contrast, as shown in FIGS. 2, 6 and 7, a reception pattern 60, a projection 70, and a light-shielding pattern 80 are formed on the glass substrate 11 outside the display area R1.

The reception pattern 60 is formed like a rectangular frame. The reception pattern 60 has first and second frames 61 and 62 formed in a rectangular shape. The first frame 61 is formed along the periphery of the color filter 4 (display area R1). The second frame 62 is formed opposite to the color filter 4 through the first frame 61, and spaced apart from the first frame 61. The reception pattern 60 forms a groove 63 between the first and second frames 61 and 62. In this embodiment, the first and second frames 61 and 62 are made of the same material as the colored layer 30G.

The projection 70 is formed in a part of the groove 63 adjacent to the first frame 61, and is extended in the first coating direction d1a. The projection 70 is located at a corner of the reception pattern 60. The projection 70 controls the flow of light-shielding ink as lightproof material as described later. In this embodiment, the projection 70 is made of the same material as the colored layer 30B. The projection 70 is formed in a rectangle shape.

The light-shielding pattern 80 is formed like a frame, a rectangular frame, here. The light-shielding pattern 80 is formed by coating the groove 63 with light-shielding ink several times by an ink-jet method or a dispenser method. In this embodiment, the light-shielding pattern 80 is formed by an ink-jet method. The light-shielding pattern 80 includes a first light-shielding part 81 formed by applying (discharging) light-shielding ink to the groove 63 along the first coating direction d1a, and a second light-shielding part 82 formed by applying (discharging) light-shielding ink to the groove 63 in the second coating direction d2a.

In this embodiment, the reception pattern 60, projection 70 and light-shielding pattern 80 are formed in the area except a part opposing a liquid crystal injection port 52 to be described later. Thus, the reception pattern 60 and light-shielding pattern 80 are interrupted by the part opposing the liquid crystal injection port 52.

As shown in FIGS. 1, 2, 5 and 6, the counter substrate 2 has a glass substrate 41 as a transparent insulating substrate. On the glass substrate 41, a counter electrode 42 and an alignment film 43, which are made of transparent conductive material such as ITO, are sequentially formed.

The array substrate 1 and counter substrate 2 are arranged opposite to each other with a predetermined gap by the columnar spacers 27. The array substrate 1 and counter substrate 2 are bonded together by a rectangular frame-like sealing member 51 provided outside the display area R1 of both substrates. The sealing member 51 is located outside the second frame 62. The liquid crystal layer 3 is formed in the area surrounded by the array substrate 1, counter substrate 2, and sealing member 51. The liquid crystal inlet 52 is formed in a part of the sealing member 51. The liquid crystal inlet 52 is sealed with a sealant 53.

Next, detailed explanation will be given of a configuration and a manufacturing method of the liquid crystal display panel.

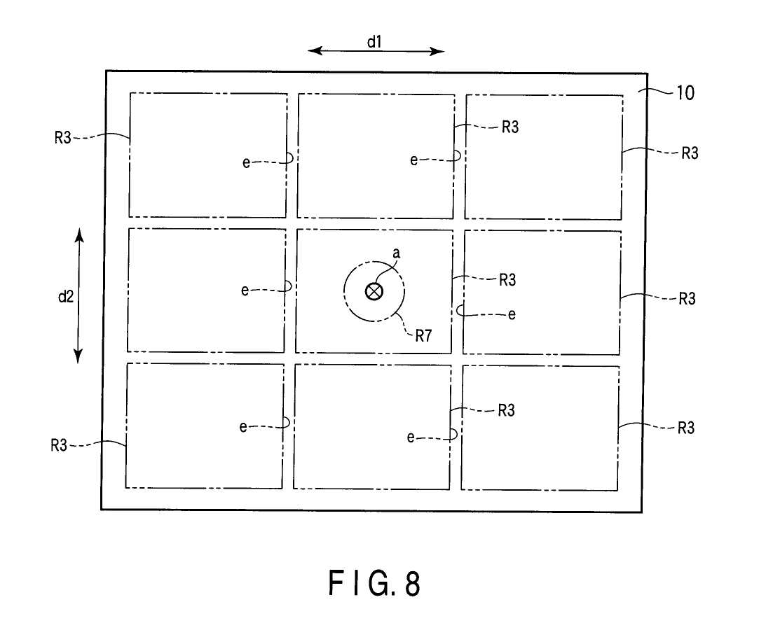

As shown in FIG. 8, first a mother glass 10 larger than the array substrate 1 is prepared as a transparent insulating substrate. In this embodiment, the mother glass 10 has nine rectangular effective areas R3 provided parallel in the first and second directions d1 and d2, forming the array substrate 1. In each effective area R3, sides extend in the first and second directions d1 and d2. A drip area R7 is formed over the axis a of rotation of the mother glass 10 in a coating process using a spin coating method, where resist is dripped.

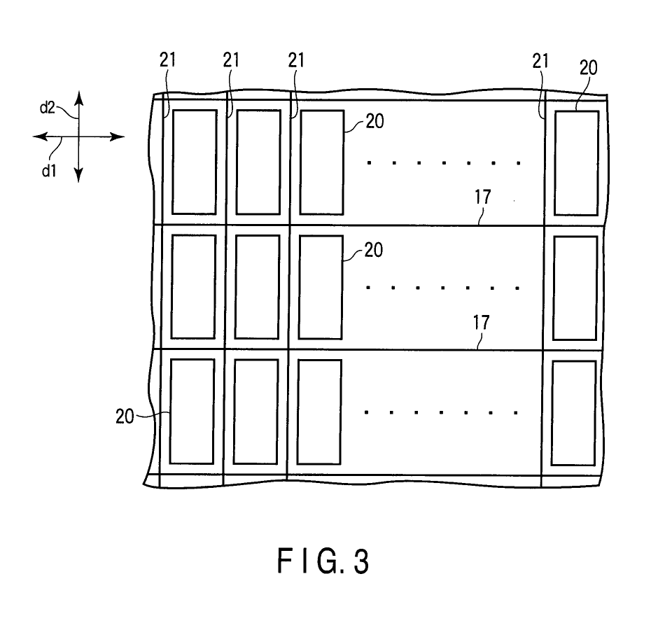

As shown in FIGS. 3 to 6 and FIG. 8, the TFTs 19, signal lines 21, scanning lines 15, auxiliary capacitor lines 17, and protective insulating film 23 are formed in each effective area R3 on the prepared mother glass 10 by an ordinary manufacturing process repeating formation of film and patterning. Thereafter, the color filter 4 is formed on the display area R1 in the effective area R3.

When the color filter 4 is formed, first, ultraviolet-curable acrylic resin mixed with green pigment (called a green resist hereinafter) is dripped on the drip area R7 on the mother glass 10, and the mother glass 10 is rotated, thereby the green resist is coated on the whole surface of the mother glass 10 by a spin coating method.

Then, the mother glass 10 coated with the green resist is pre-baked at about 90° C. for about 5 minutes, and the mother glass is exposed by using a predetermined photomask. Thereby, the green resist is cured at a location desired to leave. A photomask used for the exposure has a pattern for forming the colored layer 30G, a pattern for forming the contact hole 25, and a pattern for forming the first and second frames 61 and 62. When the mother glass is exposed, ultraviolet rays are radiated to the green resist at the exposure amount of 150 mJ/cm².

Thereafter, the green resist is developed for about 40 seconds in an aqueous solution of tetramethylanmonium hydride (TMAH) of about 0.1 wt %, and washed with water to eliminate unnecessary green resist. Then, the green resist is post-baked at 200° C. for about one hour.

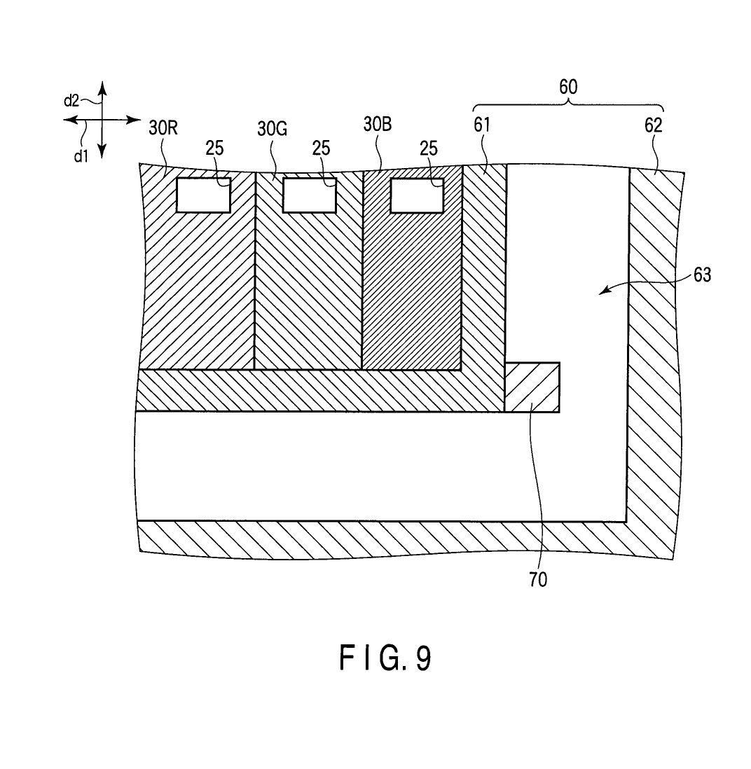

As shown in FIGS. 3 to 6 and FIGS. 8 and 9, the green resist is subjected to patterning by a photolithography method as described above, thereby forming the colored layers 30G having contact holes 25, and the first and second frames 61 and 62 in the effective area R3.

The colored layers 30G are extended in the second direction d2, and spaced parallel in the first direction d1. The reception pattern 60 (first and second frames 61 and 62) is made of the same material as the colored layers 40G. The reception pattern 60 forms the groove 63. The reception pattern 60 is partially disconnected.

Next, infrared-curable acrylic resin mixed with red pigment (called a red resist hereinafter) is dripped on the drip area R7 on the mother glass 10, on which the first and second frames 61 and 62 are formed, and the mother glass 10 is rotated, thereby the red resist is coated on the whole surface of the mother glass 10 by a spin coating method. Then, patterning is performed, thereby the colored layers 30R having the contact holes 25 are formed in the display area R1.

The colored layers 30R are extended in the second direction d2, and spaced parallel in the first direction d1. The colored layers 30R are formed adjacent to the side edge of the colored layers 30G.

Then, ultraviolet-curable acrylic resin mixed with blue pigment (called a blue resist hereinafter) is dripped on the drip area R7 on the mother glass 10, on which the colored layers 30G, first frame 61, second frame 62, and colored layer 30R are formed, and the mother glass 10 is rotated, thereby the blue resist is coated on the whole surface of the mother glass 10 by a spin coating method. Then, patterning is performed, thereby the projections 70 and the colored layers 30B having the contact holes 25 are formed.

The colored layers 30B are extended in the second direction d2, and spaced parallel in the first direction d1. The colored layers 30B are adjacent to the side edges of the colored layers 30G and 30R. The projection 70 is made of the same material as the colored layer 30B.

In the above process, a color filter 4 is formed in each display area R1.

After the color filter 4 is formed, ultraviolet-curable acrylic resin is coated on the whole surface of the mother glass 10, and columnar spacers 27 are formed in the same process as forming the colored layers.

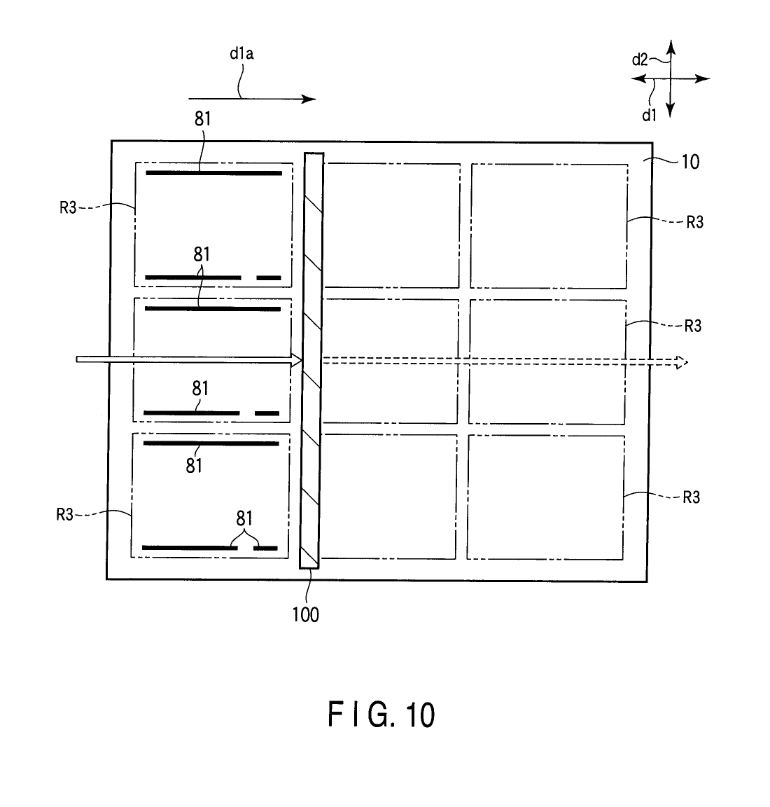

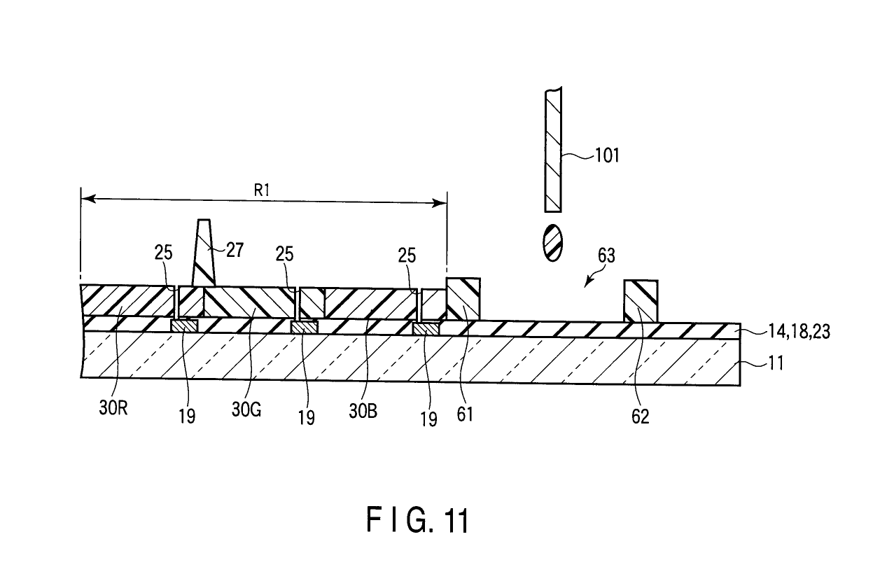

As shown in FIGS. 10 and 11, an ink-jet unit 100 is prepared as a coating unit. The ink-jet unit 100 is provided with nozzle heads 101 like crossbars. The nozzle heads 101 are aligned with a predetermined space.

After the columnar spacers 27 are formed, light-shielding ink as lightproof material is applied (discharged) to the groove 63 in the first coating direction d1a by using the ink-jet unit 100. Each time the ink is applied (discharged), the unit is moved by a certain distance in the first coating direction d1a. The light-shielding ink used here is a resin mixed with black pigment including a light-shielding resin dispersed in solvent or solution including acrylic monomer. The first coating direction d1a is a direction parallel to the first direction d1.

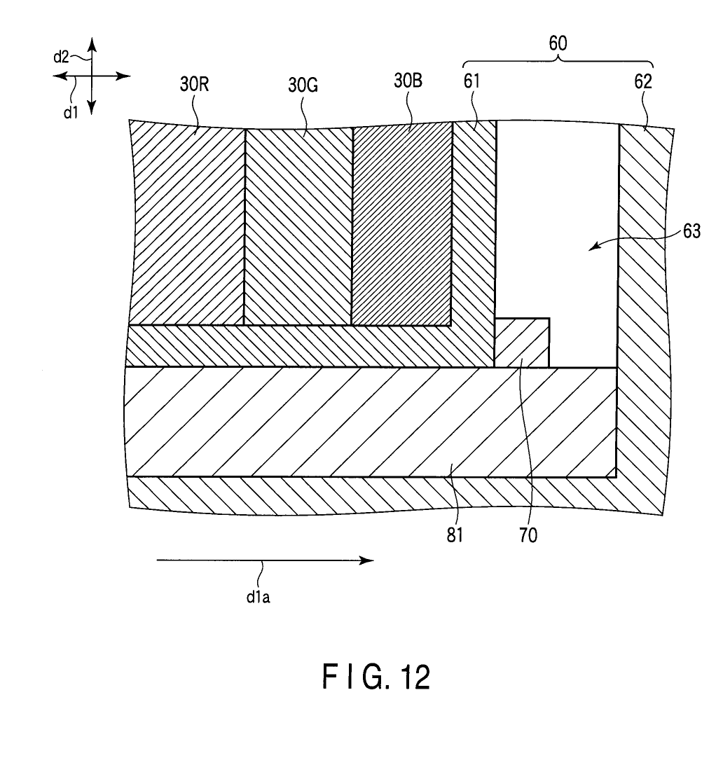

As shown in FIGS. 10 to 12, the light-shielding ink is discharged from the nozzle port at the distal end of the nozzle head 101, the flow of the ink is controlled by the projection 70, and a first light-shielding part 81 with a thickness of 1.8 μm is formed. The first light-shielding part 81 is partially disconnected.

The nozzle head 101 can be inclined to a desired angle from the position vertical to the surface of the mother glass 10. Therefore, the light-shielding ink can be discharged by intermittently moving the ink-jet unit 100 with the nozzle head 101 inclined.

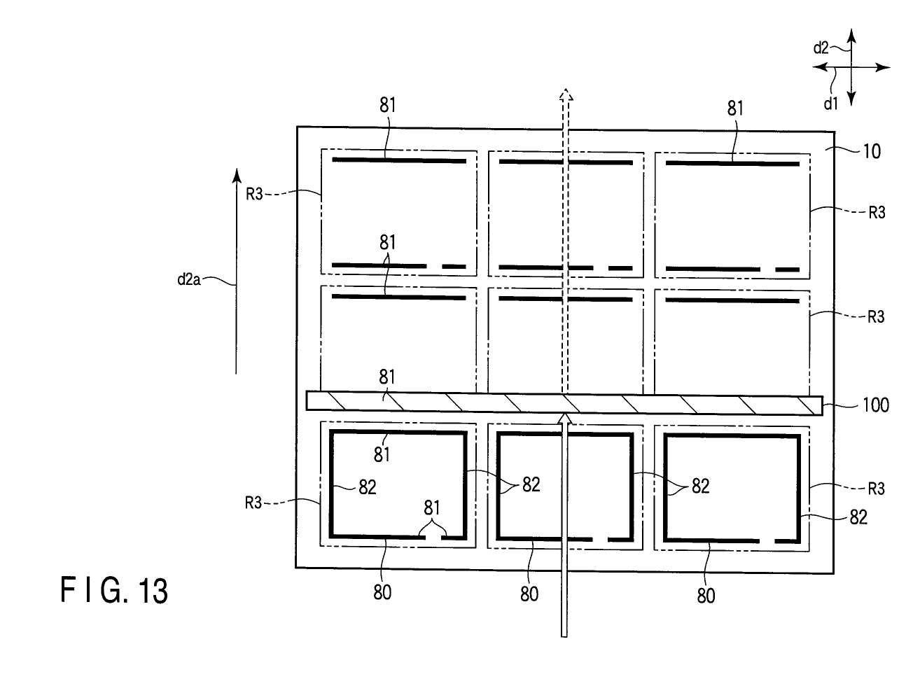

As shown in FIG. 13, after the first light-shielding part 81 is formed, light-shielding ink as a lightproof material is applied (discharged) to the groove 63 in the second coating direction d2a by using the ink-jet unit 100. Whenever the ink is coated (discharged), the unit is moved by a certain distance in the second coating direction d2a. The second coating direction d1a is a direction parallel to the second direction d2.

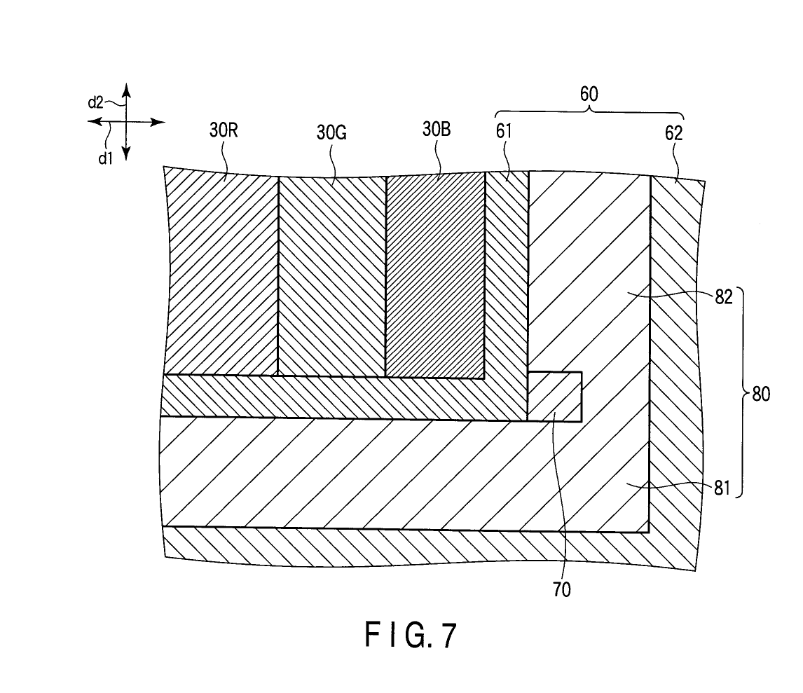

The light-shielding ink is discharged from the nozzle port at the distal end of the nozzle head 101, and a second light-shielding part 82 with a thickness of 1.8 μm is formed (FIG. 7). As described above, the frame-like light-shielding pattern 80 is formed by coating the groove 63 with light-shielding ink several times by using an ink-jet method.

After the light-shielding pattern 80 is formed, a conductive film is formed by depositing ITO on the whole surface of the mother glass 10 by a spattering method, for example. Then, pixel electrodes 26 are layered on the color filters 4 by patterning the conductive film.

Then, an alignment film material such as polyimide is applied to the whole surface of the mother glass 10, and the alignment film 28 is formed in each display area R1 by patterning. Then, the alignment films 28 are subjected to predetermined alignment film treatment (rubbing), thereby forming nine array substrates 1 on the mother glass 10.

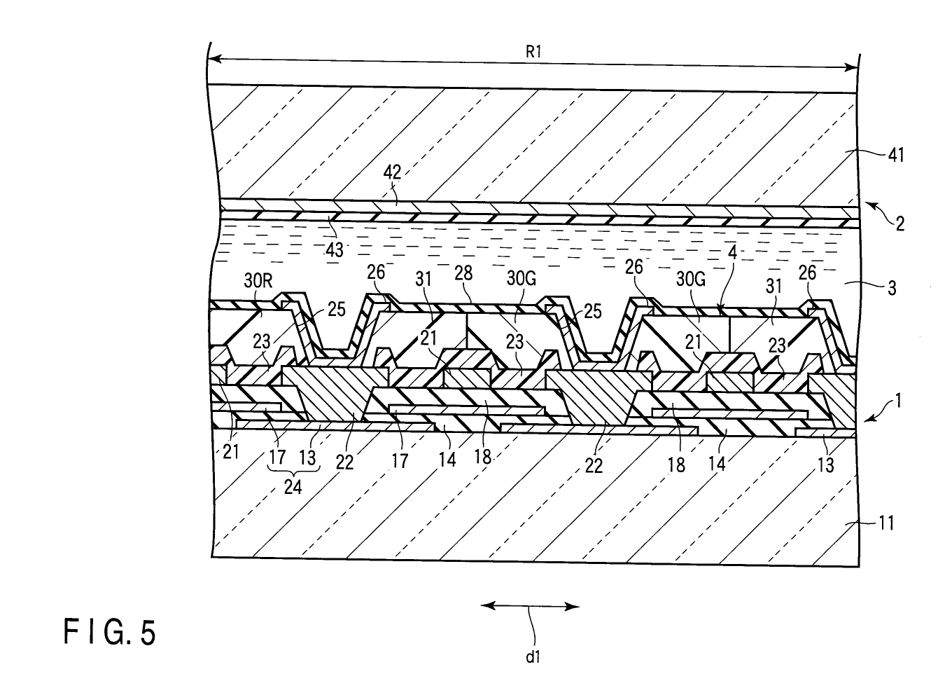

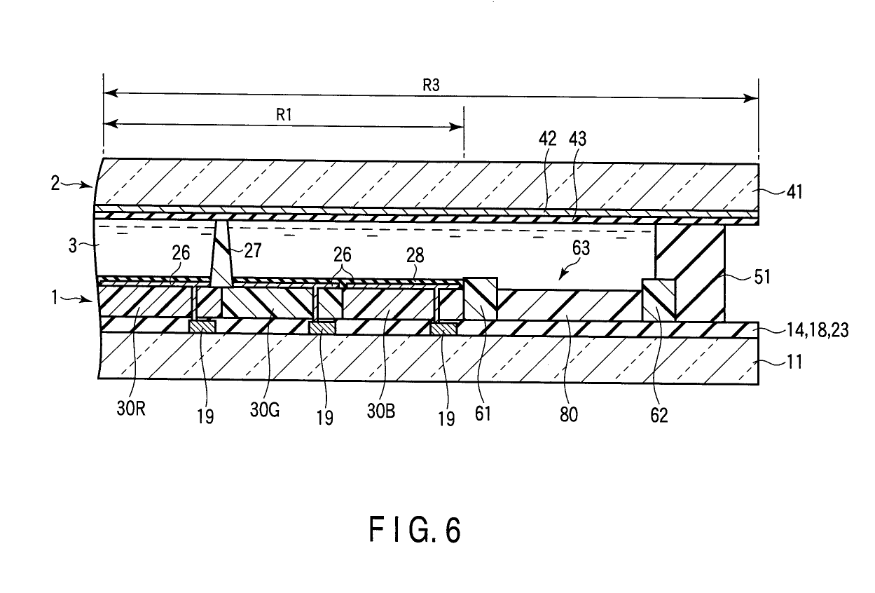

In contrast, as shown in FIGS. 5 and 6, another not-shown mother glass larger than the counter substrate 2 is prepared as a mother substrate as a transparent insulating substrate. In this embodiment, another mother glass has nine effective areas R3 for forming the counter substrate 2, spaced parallel in the first and second directions d1 and d2, as in the mother glass 10.

A conductive film is formed by depositing ITO on the whole surface of the other prepared mother glass by a spattering method, for example. Then, counter electrodes 42 are formed in the effective areas R3 by patterning the conductive film.

Then, an alignment film material such as polyimide is applied to the whole surface of the other mother glass, and the alignment film 43 is formed in each effective area R3 by patterning. Then, the alignment films 43 are subjected to predetermined alignment film treatment (rubbing), thereby forming nine counter substrates 2 on the other mother glass.

Next, the mother glass 10 with the array substrates 1 formed thereon and another mother glass with the counter substrates 2 formed thereon are held apart with a predetermined gap by the columnar spacers 27. The mother glass 10 and other mother glass are bonded with the sealing members 51 provided in the peripheral edge portions of the array substrate 1 and counter substrate 2 arranged opposite to each other.

Thereafter, the mother glass 10 and other mother glass are placed in a sealing jig, air is exhausted, and the mother glasses are baked for 30 minutes at a hardening temperature of about 170° C. Thereafter, each array substrate 1 is cut out from the mother glass 10, and each counter substrate 2 is cut out from other mother glass. As a result, nine empty liquid crystal cell sets can be obtained.

Next, a nematic liquid crystal material added by a chiral material is injected between the substrates having the empty liquid crystal cells, through the liquid crystal inlet 52 formed in the sealing member 51, by a vacuum injection method. Then, the liquid crystal inlet 52 is sealed by the sealant 53 such as ultraviolet-curable resin. Thereby, liquid crystal is encapsulated into the area surrounded by the array substrate 1, counter substrate 2, and sealing member 51, thereby the liquid crystal layer 3 is formed. Then, nine liquid crystal display panels are completely formed. A polarizer is provided on both sides of the liquid crystal display panel in a later process, which is not shown in the drawing.

According to the liquid crystal display panel configured as described above, and a method of manufacturing a liquid crystal display panel, the projection 70 is formed in the groove 63. Therefore, when light-shielding ink is applied (discharged) to the groove 63 in the first coating direction d1a, the flow of the ink is controlled by the projection 70. When the light-insulating ink is applied (discharged) to the groove 63 in the second coating direction d2a, the ink is not unnecessarily refused, and the ink is filled in the groove 63 in a good condition. As the light-shielding pattern 80 can be formed in the groove 63 without a clearance, leakage of light from the outside of the display area R1 can be prevented.

When the color filter 4 is formed, the reception pattern 60 and projection 70 can be formed at the same time by using the same material. Therefore, the reception pattern 60 and projection 70 can be formed without increasing the number of manufacturing steps.

As described above, it is possible to provide the array substrate 1 which constitutes a liquid crystal display panel with an excellent display quality, and the liquid crystal display panel.

Next, an explanation will be given of a liquid crystal display panel to be compared with this embodiment.

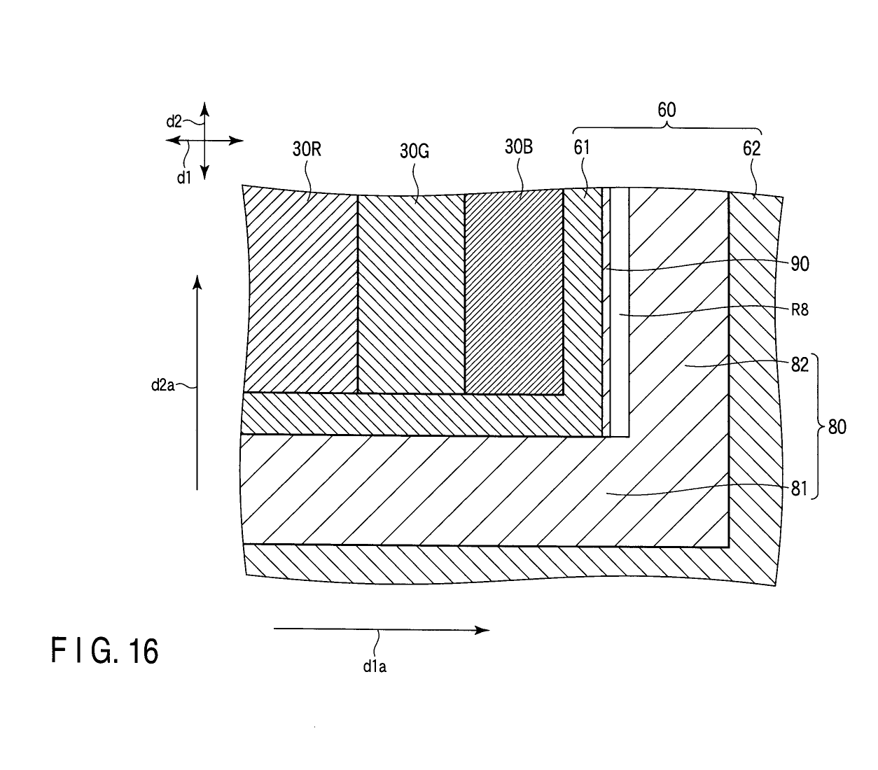

In the comparative example shown in FIG. 16, the array substrate 1 is not provided with the projection 70. Except for this point, the configuration of the comparative liquid crystal display panel is the same as the embodiments described herein.

In this configuration, when light-shielding ink is applied (discharged) in the first coating direction d1a, the ink flows in the second direction d2 along the reception pattern 60, and a flow-out part 90 is formed in the second direction d2. As a result, when the ink is applied (discharged) in the second coating direction d2a, the ink is refused by the flow-out part 90, and a light leakage (light omission) area R8 where the light-shielding ink cannot be applied is formed.

The invention is not limited to the embodiments described herein. The invention may be embodied in stages of implementation by modifying the constituent element without departing from its essential characteristics. The invention may be embodied in other specific forms by appropriately combining the constituent elements disclosed in the embodiments described herein. For example, some of the constituent elements disclosed in the embodiments may be eliminated.

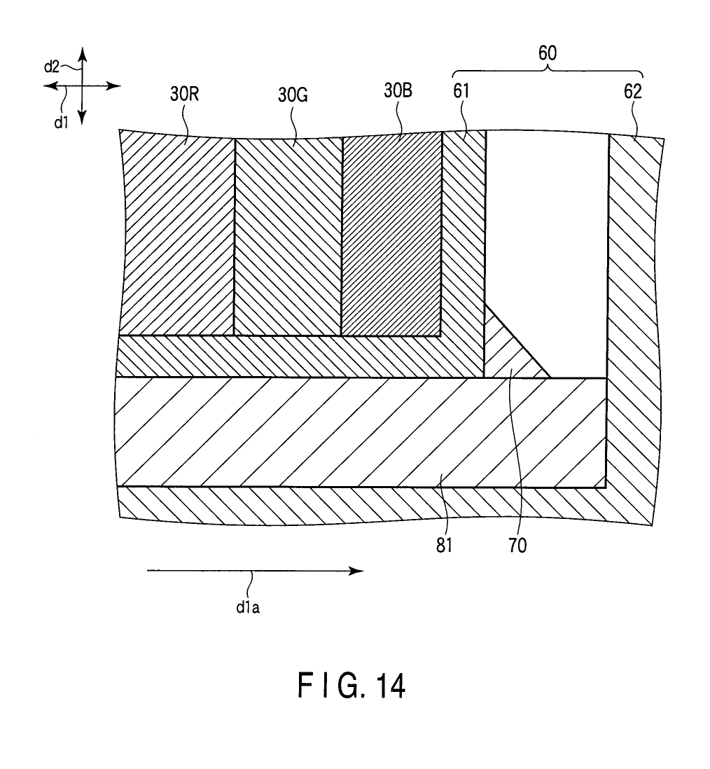

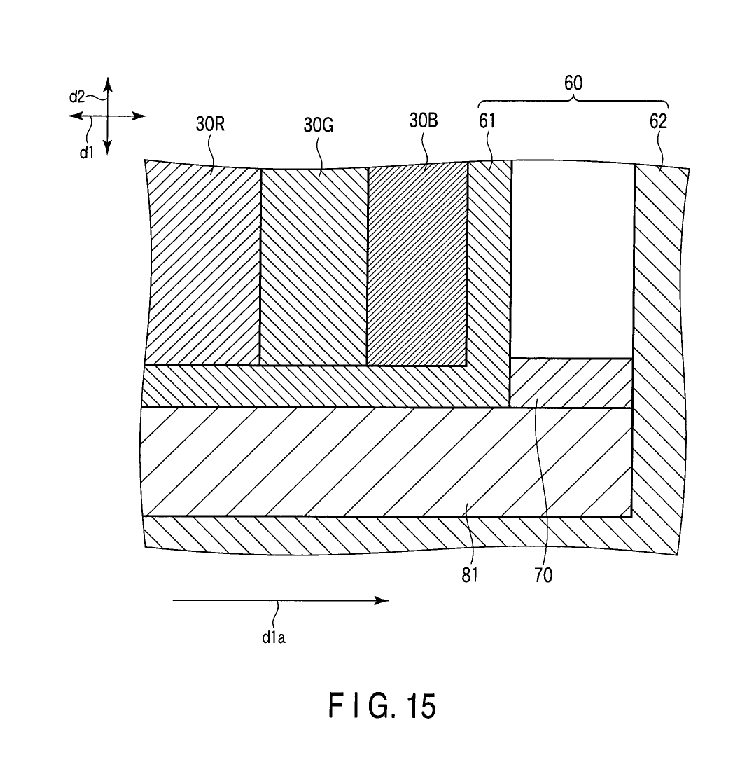

For example, the projection 70 is not limited to a rectangular shape. As shown in FIG. 14, the projection 70 may be formed in a triangular shape. The projection 70 may be any shape as long as it can control the flow of light-shielding ink. Further, as shown in FIG. 15, the projection may be formed to connect the first frame 61 and second frame 62, and may be set to any desired length.

The projection 70 may be formed at the same time of the colored layers 30R and 30G or columnar spacer 27 by using the same material. If the projection 70 is made of the blue resist with the lowest reflection coefficient among the green resist, red resist, and resist used for a columnar spacer, the reflection of outside light entering through the counter substrate 2 can be prevented, and the contrast can be improved. Further, the projection 70 is coated with a film in the same process as the colored layer 30B, and the height of the projection 70 is the same as the colored layer 30B (2 to 4 μm).

If the projection 70 is made of a resist than the blue resist (e.g., green or red resist), the contrast improvement rate is decreased, but the same effect as the blue resist can be obtained in prevention of the flow of light-shielding ink. This results from the fact that the projection 70 is formed in the same process as each color layer, and the height of the projection 70 is the same as each colored layer.

Since the projection 70 is formed as described above, a sufficient height of the projection 70 to control the flow of light-shielding ink is ensured, and the flow of ink along the reception pattern 60 can be controlled.

The projection 70 may be formed in a process different from the colored layers and columnar spacer 27. In this case, the projection 70 may be made of a positive resist, negative resist, acrylic resin, novolac resin, or any photosensitive resin capable of patterning by using an exposing process.

The projection 70 may be formed by laminating two or more layers by using green, red and blue resists. The projection 70 may be formed as one piece with the first frame 61 (reception pattern 60).

If a drip injection method is used as a liquid crystal injection method, the reception pattern 60 and light-shielding pattern 80 can be formed all around the area outside the display area R1.

A dispenser unit may be used as a coating unit. In this case, light-shielding ink may be coated by using a dispenser method.

The color filter 4 may be formed on the counter substrate 2. In this case, an insulating film may be formed instead of the color filter 4, and the reception pattern 60 and projection 70 may be formed in different processes.

What is claimed is:

1. An array substrate comprising:
scanning lines provided on a substrate, and layered on a display area;
signal lines provided on the substrate, layered on the display area, and intersected with the scanning lines;
switching elements provided close to the intersections of the scanning lines and signal lines;
an insulating film formed on the substrate, scanning lines, signal lines and switching elements layered, in being layered on the display area;
a reception pattern which has a first frame formed along the periphery of the insulating film, and a second frame formed opposite to the insulating film through the first frame, and spaced apart from the first frame, in which a groove is formed between the first frame and second frame;
a projection which is formed in a part of the groove adjacent to the first frame, extended in a first coating direction, and controls the flow of light-shielding material; and
a frame-like light-shielding pattern, which includes a first light-shielding part formed by coating the groove with the light-shielding material in the first coating direction by using an ink-jet method or a dispenser method, and is formed by coating the groove several times with the light-shielding material by using an ink-jet method or a dispenser method.

2. The array substrate according to claim 1, wherein the display area is formed in a rectangular shape, the reception pattern is formed like a rectangular frame, and the projection is located at a corner of the reception pattern.

3. The array substrate according to claim 1, wherein the projection is formed as one piece with the first frame.

4. The array substrate according to claim 1, wherein the insulating film is a color filter having colored layers.

5. The array substrate according to claim 4, wherein the projection is made of the same material as the colored layers.

6. The array substrate according to claim 4, wherein the reception pattern is made of the same material as the colored layers.

7. The array substrate according to claim 4, wherein the color filter has red, green and blue colored layers, and the projection is made of the same material as the blue colored layer.

8. The array substrate according to claim 4, wherein the color filter has red, green and blue colored layers, and the projection is formed by laminating the same material as at least two of the red, green and blue colored layers.

9. The array substrate according to claim 1, further comprising columnar spacers formed on the insulating film, wherein the projection is made of the same material as the columnar spacers.

10. A liquid crystal display panel comprising:
an array substrate comprising scanning lines provided on a substrate, and layered on a display area; signal lines provided on the substrate, layered on the display area, and intersected with the scanning lines; switching elements provided close to the intersections of the scanning lines and signal lines; an insulating film formed on the substrate, scanning lines, signal lines and switching elements layered, in being layered on the display area; a reception pattern which has a first frame formed along the periphery of the insulating film, a second frame formed opposite to the insulating film through the first frame, and spaced apart from the first frame, in which a groove is formed between the first frame and second frame; a projection which is formed in a part of the groove adjacent to the first frame, extended in a first coating direction, and controls the flow of light-shielding material; and
a frame-like light-shielding pattern, which includes a first light-shielding part formed by coating the groove with the light-shielding material in the first coating direction by using an ink-jet method or a dispenser method, and is formed by coating the groove several times with the light-shielding material by using an ink-jet method or a dispenser method;
a counter substrate arranged opposite to the array substrate; and
a liquid crystal layer held between the array substrate and counter substrate.
